(19) United States
(12) Patent Application Publication
(10) Pub. No.: US 2006/0130989 A1
(43) Pub. Date: Jun. 22, 2006

(54) Tissue products treated with a polysiloxane containing softening composition that are wettable and have a lotiony-soft handfeel

(75) Inventors: Kou-Chang Liu, Appleton, WI (US); Laura Leigh Boudrie, Appleton, WI (US); Michael John Smith, Neenah, WI (US); Steven Patrick Jones, Neenah, WI (US); John Jerald Urlaub, Oshkosh, WI (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 11/022,283

(22) Filed: Dec. 22, 2004

(51) Int. Cl. D21H 21/22; D21H 27/30; D21H 23/50; B05B 15/02

(52) U.S. Cl. 162/135; 162/158; 424/402; 162/134

(57) ABSTRACT

A softening composition for treating tissue products is disclosed. The softening composition comprises a combination of particular amino-functional polysiloxanes and alkoxylated alcohols in particular proportionate amounts. When applied to tissue products at add-on levels of less than about 5% by weight, the softening composition has been found not only to improve the softness of the product but also not to substantially interfere with the wettability characteristics of the sheet.

### BACKGROUND OF THE INVENTION

Consumers use paper-wiping products, such as facial tissues and bath tissues, for a wide variety of applications. Facial tissues are not only used for nose care but, in addition to other uses, may also be used as a general wiping product. Consequently, there are many different types of tissue products currently commercially available.

In some applications, tissue products are treated with softening agents in order to increase the softness of the tissue. Adding softening agents to a tissue may impart improved softness to the tissue while maintaining the tissue's strength and reducing the amount of lint produced by the tissue during use. For example, tissue products treated with amino-functional polysiloxanes have a silky-soft handfeel. In addition to polysiloxanes, long chain alkyl chemicals are also used as softeners. These chemicals provide tissue products with a lotiony, greasy-soft handfeel.

In some applications, tissue products may be treated with other beneficial agents as well. For example, in addition to softening agents such as polysiloxane lotions, other desirable agents may be added to a tissue in order to provide a benefit to the user. For example, vitamins, plant extracts, medications, antimicrobial compounds, and the like may also be added to the web in order to transfer the desired agent to the consumer upon use.

Some additives, however, such as softening agents, may have a tendency to impart hydrophobicity to the treated tissue web, reducing the wettability characteristics of the web. Although hydrophobicity may be desirable in some applications, in other applications, increased hydrophobicity may adversely affect the product. For instance, increased hydrophobicity in a bath tissue may prevent the bath tissue from being wetted in a sufficient amount of time and prevent disintegration and dispersing when disposed in a commode or toilet. Hence, in some applications, it is difficult to find a proper balance between softness and absorbency, both of which are desirable attributes for tissues, particularly bath tissues.

Thus, a need currently exists for a softening composition that, when uniformly treated on the surface of a tissue product can provide the product with a lotiony-soft handfeel without completely degrading the wettability characteristics of the product. For example, a need exists for a bath tissue that may be treated on opposite sides with a softening composition for improving the softness of the product while still retaining a product that rapidly wets when immersed in water.

### SUMMARY OF THE INVENTION

In general, the present disclosure is directed to an improved softening composition that, when applied to a tissue product, is capable of improving the softness of the product. In particular, the softening composition is capable of providing the tissue product with a non-greasy, lotiony-soft handfeel. Of particular advantage, the softening composition is capable of being applied to a tissue product without significantly reducing the wettability characteristics of the product. Tissue products that may be treated in accordance with the present invention include facial tissues, paper towels, wiping products, and the like. In one particular embodiment, for example, the softening composition of the present invention is particularly well suited to being applied to bath tissue. For instance, opposite sides of a bath tissue may be uniformly coated with a softening composition of the present invention and still retain a wet-out time of no greater than about 8 seconds.

As used herein, “Wet Out Time” is related to absorbency and is the time it takes for a given sample to completely wet out when placed in water. More specifically, the Wet Out Time is determined by cutting 20 sheets of the tissue sample into 2.5 inch squares. The number of sheets used in the test is independent of the number of plies per sheet of product. The 20 square sheets are stacked together and stapled at each corner to form a pad. The pad is held close to the surface of a constant temperature distilled water bath (23+/−2° C.), which is the appropriate size and depth to ensure the saturated specimen does not contact the bottom of the container and the top surface of the water at the same time, and dropped flat onto the water surface, staple points down. The time taken for the pad to become completely saturated, measured in seconds, is the Wet Out Time for the sample and represents the absorbent rate of the tissue. Increases in the Wet Out Time represent a decrease in absorbent rate.

In one particular embodiment, for instance, the present invention is directed to a tissue product comprising at least one tissue web containing pulp fibers. The tissue product, for example, may comprise a single ply product or a multi-ply product. In one particular embodiment, the tissue product comprises a single ply product containing an uncreped, through-air dried web.

In accordance with the present invention, the tissue product is treated on at least one side with a softening composition. The softening composition comprises from about 5% to about 30% by weight of an amino-functional polysiloxane having the following structure: 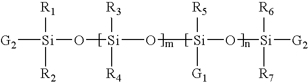
wherein,
m is 10 to 100,000;
n is 1 to 5,000;
G₁ is R₈ or R₁₀—[X—R₁₁]ₛ—Y—R₁₂;
G2 are independently R9, a hydroxyl radical, an alkoxyl radical, or
R₁₀—[X—R₁₁]ₛ—Y—R₁₂;
R₁ through R₉ are independently selected from the group consisting of C₁ to C₈ substituted or unsubstituted, aliphatic or aromatic alkyl radicals;
R₁₀ and R₁₁ are independently a substituted or unsubstituted C₂ to C₆ alkylene diradical;
X and Y are independently a NR₁₃ diradical;
R₁₂ and R₁₃ are independently a hydrogen or a substituted or unsubstituted C₁ to C₂₀ alkyl radical; and
S is 0 or 1.

In addition to an amino-functional polysiloxane, the softening composition further includes from about 70% to about 95% by weight of a chemical having the following structure:
R₁₄—O—[C₂H₄O]_{d}—[C₃H₆O]ₑR₁₅

wherein,

R₁₄ is a saturated or unsaturated, substituted or unsubstituted, primary or secondary straight chain or branched or cyclic C₆ to C₄₀ alkyl radical;

R₁₅ is a hydrogen radical or a C₁ to C₆ alkyl radical;

d is 5 to 40; and

e is 0 to 20.

The above softening composition is applied to the tissue product in a manner and in an amount such that the tissue product has a wet-out time of less than about 8 seconds, such as less than about 7 seconds or less than about 6 seconds. In one particular embodiment, for instance, the tissue product may have a wet-out time of less than about 5 seconds.

The softening composition may be present on both sides of the tissue product and may be applied uniformly over the surface of each side. For example, the softening composition may cover from about 20% to about 100%, such as from about 40% to about 95% of the surface area of each side of the product. The total solid add-on of the softening composition to the tissue product may be from about 0.5% to about 5% by weight.

In one embodiment, the softening composition can further contain a skin conditioning agent in an amount from about 0.01% to about 5% by weight. The skin conditioning agent may comprise, for instance, aloe, Vitamin E, a herb, a herb extract, petrolatum, and the like.

The present disclosure is also directed to a process for producing a tissue product. The process includes the step of applying a softening composition as described above to one or both sides of a tissue sheet. The softening composition may be applied to the tissue sheet using various techniques. For example, in one embodiment, the softening composition may be printed onto the tissue sheet using, for instance, a gravure printer. In this embodiment, the softening composition may be contained in an emulsion that contains from about 40% to about 90% water.

In an alternative embodiment, the softening composition may be applied to the tissue sheet in a substantially neat form. In this embodiment, for instance, an extruder such as an extruding die or a uniform fiber depositer may be used to apply the composition. In still another embodiment, the composition may be combined with water and sprayed onto the tissue sheet.

Other features and aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a schematic diagram of an uncreped through-air dried process for making tissue webs for use in the present invention;

FIG. 2 is a schematic diagram of one embodiment for applying a softening composition to both sides of a tissue web in accordance with the present invention; and

FIG. 3 is a schematic diagram of an alternative embodiment of a process for applying a softening composition to a tissue web in accordance with the present invention.

Repeat use of reference characters in the present specification and drawings is intended to represent the same or analogous features of the invention.

### DETAILED DESCRIPTION OF THE INVENTION

Reference now will be made to the embodiments of the invention, one or more examples of which are set forth below. Each example is provided by way of explanation of the invention, not as a limitation of the invention. In fact, it will be apparent to those skilled in the art that various modifications and variations may be made in the invention without departing from the scope or spirit of the invention. For instance, features illustrated or described as part of one embodiment may be used in another embodiment to yield a still further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied in the exemplary constructions.

In general, the present disclosure is directed to applying a softening composition to a tissue product in order to provide the product with a non-greasy, lotiony-soft handfeel. Of particular advantage, the softening composition of the present invention has been formulated such that the composition may be applied to a tissue product without substantially interfering with the wettability characteristics of the product.

More particularly, in order to obtain a treated tissue product having the desired properties, the softening composition of the present invention contains an amino-functional polysiloxane in combination with an alkoxylated alcohol and optionally a skin conditioning agent. The amino-functional polysiloxane is present in the softening composition in a particular weight ratio in relation to the alkoxylated alcohol. By having the relative amounts of the amino-functional polysiloxane and the alkoxylated alcohol within controlled limits and by limiting the add-on to the tissue web, the present inventors have found that tissue products can be produced that not only have improved softness but also have relatively low wet-out times. Thus, the softening composition of the present invention is well suited to treating bath tissue products.

In general, any suitable tissue product may be treated in accordance with the present invention. The tissue product may be a single ply product or a multiply product. The plies of the tissue product may generally be formed in any of a variety of papermaking processes known in the art. In fact, any process capable of forming a tissue web may be utilized in the present invention. For example, tissue making processes of the present invention may utilize adhesive creping, wet creping, double creping, embossing, wet-pressing, air pressing, through-air drying, creped through-air drying, uncreped through-air drying, as well as other steps known in the art.

Tissue products that may be treated in accordance with the present invention include not only bath tissue and facial tissue, but may also include paper towels and industrial wipers. The tissue products may have a basis weight up to about 120 gsm, such as from about 6 gsm to about 80 gsm. Bath tissues and facial tissues, for instance, may have a basis weight of from about 10 gsm to about 45 gsm, such as from about 30 gsm to about 40 gsm.

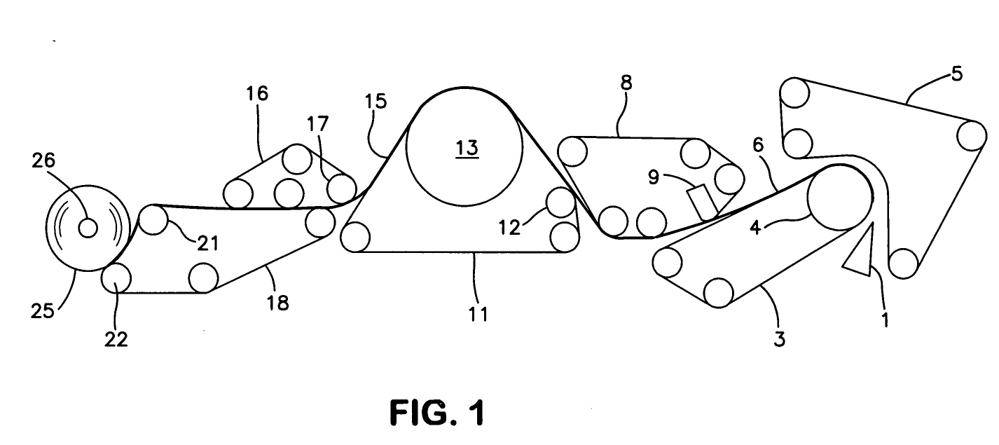

In one particular embodiment, the softening composition of the present invention is applied to a single ply uncreped through-air dried web. Referring to FIG. 1, shown is a schematic flow diagram of a throughdrying process for making uncreped throughdried tissue sheets. Shown is the headbox 1 which deposits an aqueous suspension of papermaking fibers onto an inner forming fabric 3 as it traverses the forming roll 4. Outer forming fabric 5 serves to contain the web while it passes over the forming roll and sheds some of the water. The wet web 6 is then transferred from the inner forming fabric to a wet end transfer fabric 8 with the aid of a vacuum transfer shoe 9. This transfer is preferably carried out with the transfer fabric traveling at a slower speed than the forming fabric (rush transfer) to impart stretch into the final tissue sheet.

The wet web is then transferred to the throughdrying fabric 11 with the assistance of a vacuum transfer roll 12. The throughdrying fabric carries the web over the throughdryer 13, which blows hot air through the web to dry it while preserving bulk. There can be more than one throughdryer in series (not shown), depending on the speed and the dryer capacity.

The dried tissue sheet 15 is then transferred to a first dry end transfer fabric 16 with the aid of vacuum transfer roll 17. The tissue sheet shortly after transfer is sandwiched between the first dry end transfer fabric and the transfer belt 18 to positively control the sheet path. The air permeability of the transfer belt is lower than that of the first dry end transfer fabric, causing the sheet to naturally adhere to the transfer belt. At the point of separation, the sheet follows the transfer belt due to vacuum action. Suitable low air permeability fabrics for use as transfer belts include, without limitation, COFPA Mononap NP 50 dryer felt (air permeability of about 50 cubic feet per minute per square foot) and Asten 960C (impermeable to air). The transfer belt passes over two winding drums 21 and 22 before returning to pick up the dried tissue sheet again. The sheet is transferred to the parent roll 25 at a point between the two winding drums. The parent roll is wound onto a reel spool 26, which is driven by a center drive motor.

Particularly suitable methods of producing uncreped throughdried basesheets for purposes of this invention are described in U.S. Pat. No. 6,017,417 issued Jan. 25, 2000 to Wendt et al. and U.S. Pat. No. 5,944,273 issued Aug. 31, 1999 to Lin et al., both of which are herein incorporated by reference.

As described above, the softening composition of the present invention generally comprises an amino-functional polysiloxane and an alkoxylated alcohol. The amino-functional polysiloxane is present in the softening composition in an amount from about 5% to about 30% by weight, such as from about 20% to about 30% by weight. The amino-functional polysiloxane may have the following structure: 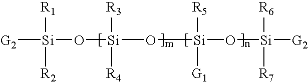
wherein,
m is 10 to 100,000;
n is 1 to 5,000;
G₁ is R₈ or R₁₀—[X—R₁₁]ₛ—Y—R₁₂;
G2 are independently R9, a hydroxyl radical, an alkoxyl radical, or
R₁₀—[X—R₁₁]ₛ—Y—R₁₂;
R₁ through R₉ are independently selected from the group consisting of C₁ to C₈ substituted or unsubstituted, aliphatic or aromatic alkyl radicals;
R₁₀ and R₁₁ are independently a substituted or an unsubstituted C₂ to C₆ alkylene diradical;
X and Y are independently a NR₁₃ diradical;
R₁₂ and R₁₃ are independently a hydrogen or a substituted or unsubstituted C₁ to C₂₀ alkyl radical; and
S is 0 or 1.

Representative species within the foregoing general structure include the following: 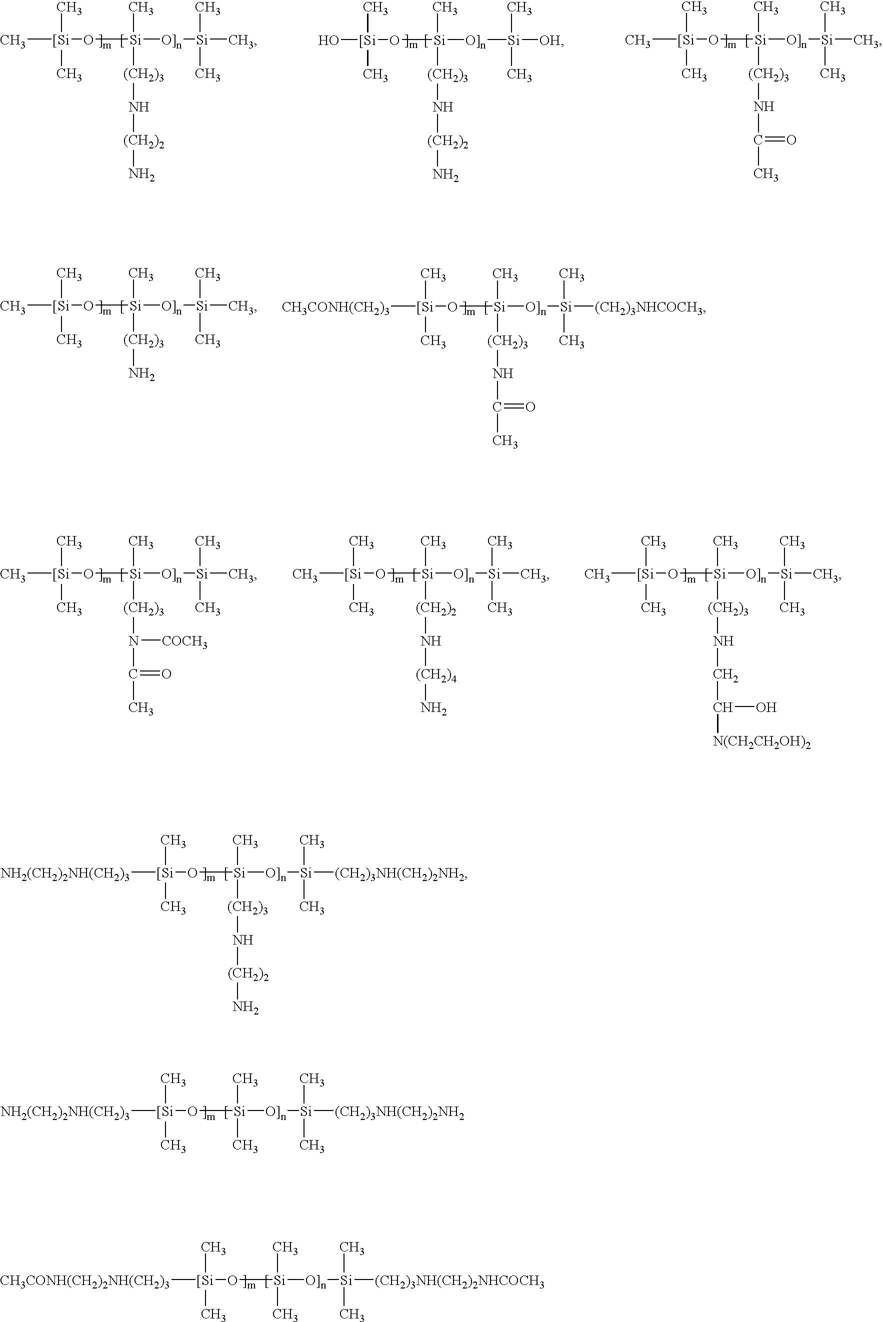 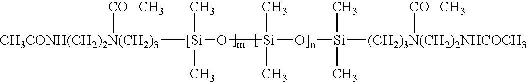
Commercially available amino-functional polysiloxanes that may be made according to the above structure are marketed by Kelmar Industries, Inc. under the tradenames AF-21, AF-23, AF-26 and HAF-1130.

The alkoxylated alcohol included in the softening composition, on the other hand, may be present in the composition in an amount from about 70% to about 95% by weight, such as from about 70% to about 80% by weight. The weight ratio of the alkoxylated alcohol to the amino-functional polysiloxane in the softening composition ranges from about 19:1 to about 2.3:1. As used herein, an “alkoxylated alcohol” refers to an ethoxylated alcohol or an ethoxylated propoxylated alcohol. The alkoxylated alcohol may have the following chemical structure:
R₁₄—O—[C₂H₄O]_{d}—[C₃H₆O]ₑR₁₅

wherein,

R₁₄ is a saturated or unsaturated, substituted or unsubstituted, primary or secondary, straight chain or branched or cyclic C₆ to C₄₀ alkyl radical;

R₁₅ is a hydrogen radical or a C₁ to C₆ alkyl radical;

d is 5 to 40; and

e is 0 to 20.

For many applications, the weight ratio of [C₂H₄O]_{d}—[C₃H₆O]ₑR₁₅ to R₁₄ is between 1:1 and 7:1.

For example, in one embodiment, the above weight ratio may be from about 1.5:1 to about 4:1.

In one embodiment, R₁₄ as indicated in the above formula may have from about 12 to about 24 carbon atoms in the carbon chain and the alcohol may be ethoxylated with from about 3 moles to about 25 moles of ethoxylate.

In addition to the polysiloxane and the alkoxylated alcohol, the softening composition may contain from about 0.01 % to about 5% by weight of other beneficial agents, such as a skin conditioning agent. For instance, in one embodiment, the composition may contain aloe, Vitamin E, a herb, or a herb extract. Other beneficial agents that may be included in the composition include, without limitation, anti-acne actives, antimicrobial actives, antifungal actives, antiseptic actives, antioxidants, cosmetic astringents, drug astringents, biological additives, deodorants, emollients, external analgesics, film formers, fragrances, humectants, natural moisturizing agents and other skin moisturizing ingredients known in the art such as lanolin, opacifiers, skin exfoliating agents, skin protectants, solvents, sunscreens, and surfactants.

The softening composition as described above may be applied to a single side of a tissue product or may be applied to opposite sides. In order to maximize an increase in softness, the softening composition may be applied to both sides of the tissue product. When added to the tissue product, the total solids add-on is generally less than about 5% by weight, such as less than about 4% by weight, or less than about 3% by weight. For example, in one embodiment, the total solids add-on may be from about 0.5% by weight to about 2.5% by weight. When applied to the tissue product, the softening composition may cover from about 20% to about 100% of the surface area of both sides of the product, such as from about 40% to about 95% of the surface area of each side.

As mentioned above, the softening composition of the present invention has been found to not only improve the handfeel of tissue products, but may also be applied so as to minimize any increase in wettability. For instance, softening compositions containing the above proportion of ingredients at the above add-on amounts may be applied to a bath tissue that still retains a wet-out time of less than about 8 seconds, such as less than about 7 seconds. For example, in one embodiment, the wet-out time of a tissue product treated in accordance with the present invention may be less than about 6 seconds, and even less than about 5 seconds. For purposes of comparison, an untreated tissue product may have a wet-out time of from about 3 seconds to about 4 seconds.

The softening composition may be applied to the tissue product using any suitable method or technique without limitation. For instance, the softening composition may be sprayed onto the tissue product, printed onto the tissue product, or released onto the tissue product using an extruder. When sprayed or printed onto a tissue sheet, the softening composition may be combined with water, preservatives, anti-foamers, and surfactants to form an emulsion. Water, for instance, may be combined with a softening composition in order to reduce the viscosity in order to print or spray the composition onto a tissue web.

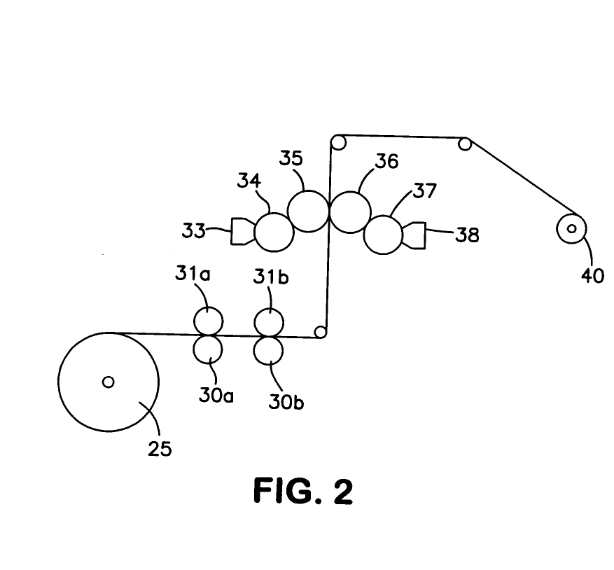

In one particular embodiment, the softening composition is contained in an emulsion and applied to a tissue web using an offset rotogravure printer as particularly illustrated in FIG. 2. When the softening composition is contained in an emulsion and applied to a tissue product by printing or spraying, the softening composition may comprise from about 10% to 60% by weight of the emulsion, such as from about 20% to about 50% by weight of the emulsion. In one particular embodiment, for instance, the softening composition may comprise from about 25% to about 45% by weight of the emulsion.

Referring to FIG. 2, shown is the parent roll 25 being unwound and passed through two calender nips between calender rolls 30a and 31a and 30b and 31b. The calendered web is then passed to the rotogravure coation station comprising a first closed doctor chamber 33 containing the emulsion of the softening composition to be applied to a first side of the web, a first engraved steel gravure roll 34, a first rubber backing roll 35, a second rubber backing roll 36, a second engraved steel gravure roll 37 and a second closed doctor chamber 38 containing the emulsion of the softening composition to be applied to the second side of the web. If both sides of the web are to be treated, the two emulsions can be the same or different. The calendered web passes through a fixed-gap nip between the two rubber backing rolls where the emulsion of the softening composition is applied to the web. The treated web is then passed to the rewinder where the web is wound onto logs 40 and slit into rolls of bath tissue.

In still another embodiment, the softening composition is extruded onto the tissue sheet using an extruder, such as a meltblown die or a uniform fiber depositer. In this embodiment, the softening composition may be applied to the tissue sheet in a substantially neat form meaning that the softening composition does not contain substantial amounts of water or other similar ingredients. For instance, when extruded onto the tissue sheet, the softening composition may contain water in an amount less than about 10% by weight, such as less than about 5% by weight. In fact, in one embodiment, the softening composition may be applied to the tissue sheet without any water added.

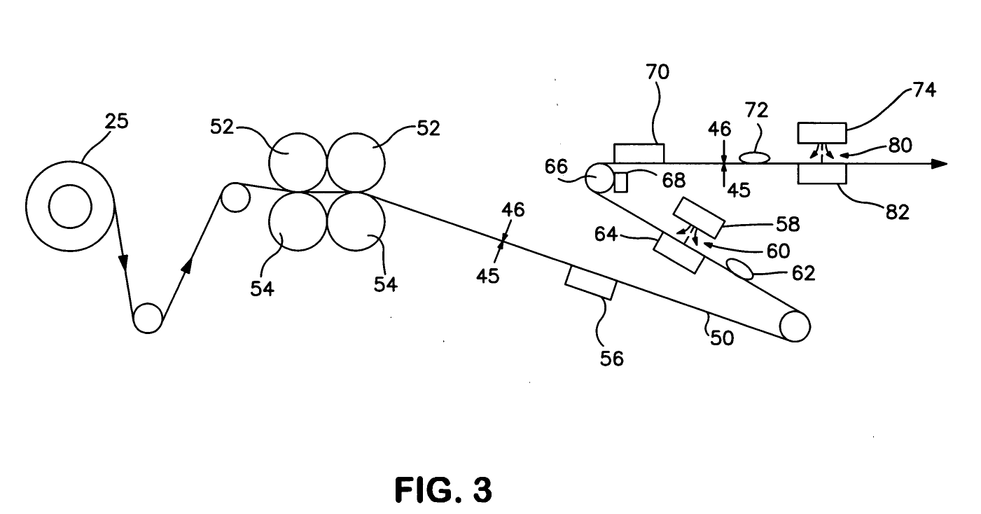

Referring to FIG. 3, for instance, one embodiment of a process for extruding the softening composition onto two sides of a tissue sheet is illustrated. In this particular embodiment, the composition may be applied to both surfaces 45, 46 of a web 50 in a post treatment process. For example, the web 50 may be unwound from a roll 25. In this embodiment, the web is calendered using calendar rolls 52 and 54 prior to application of the composition. After being calendered, the web surface 45 which will be accepting the composition may be cleaned of loose fibers and lint by sheet cleaner 56 prior to application of the composition.

The compositions which may be applied to the surface of the web according to the present invention, whether neat compositions or mixtures, tend to be not only viscous, but also very tacky. For example, one embodiment of the present invention contemplates application of a neat polysiloxane composition, which is quite tacky. In addition, paper webs tend to carry a great deal of particulate matter, with a lot of lint and loose fibers associated with the base sheet. The combination of the tacky composition and the particulates associated with the paper web at the meltblown die may cause the die tips to become clogged and block the composition flow to the web. As such, the process and system of the present invention may prevent contact between particulate matter associated with the paper web and the die tips of the meltblown die and may therefore avoid the expense of down time of production due to clogged die tips.

Cleaning the surface of the web prior to application of the composition, such as at sheet cleaner 56, may prevent build up of lint and fibers at the die tips of an extruder, such as a meltblown die 58. In the embodiment illustrated in FIG. 3, sheet cleaner 56 may be, for example, a vacuum system which may remove lint and loose fibers from the surface 45 of web 50 prior to application of the composition 60.

After the surface 45 of web 50 has been cleaned at sheet cleaner 56, a softening composition may be applied to the surface 45 of the web. In the illustrated embodiment, the composition may be applied by use of the meltblown die 58 which may extrude the composition stream and direct it to the surface of web.

In order to further protect the die tips of the meltblown die 58 from build up of lint and loose fibers, the web 50 may pass through a boundary air blocking device 62 prior to reaching the meltblown die 58. A boundary air blocking device may be, for example, a stationary blocking device or a rotary blocking device which may deflect the flow of boundary air which may travel with the web and may carry lint and fiber which may clog the meltblown die tips.

The die tips may be between about 0.5 inch and about 3 inches from the web surface 45 as the composition is applied to the web. In one embodiment, the die tips may be between about 1 inch and about 2 inches from the surface of the web during the application process.

The system may also include a vacuum box 64. The vacuum box 64 is provided to improve air flow and to employ a pneumatic force to pull the composition stream 60 down on to the first side 45 of the tissue web 50.

After the composition has been applied to the surface 45 of the web 50, the web may be guided around a roll 66 to be properly aligned for application of the composition to the second surface 46 of the web 50. In guiding the web 50 around the roll 66, the surface 45 which now carries fibers of the composition 60 will contact the roll 66. Some of the composition may stick to the roll 66 as the web 50 is guided around roll 66. In order to prevent build up of the composition on the surface of the guide roll 66, roll 66 may be cleaned with a roll cleaner 68. For example, a roll cleaner such as an oscillating brush or a vacuum device may be used to prevent build up of composition 60 on guide roll 66.

The second side 46 of web 50 may then be applied with the same or a different softening composition in a process similar to that used to apply the composition 60 to the first side 45 of the web 50. As shown, the second side of the web 46 may have excess lint and fibers removed at sheet cleaner 70 before having the composition 80 applied to the surface 46 of the web 50 with meltblown die 74. The melt blown die tips may be protected from blockage due to lint and fibers carried in the air boundary with air boundary blocking device 72. Vacuum box 82 may provide desired air flow and help direct the deposit of the composition fibers on the surface 46 of the web 50.

The flow rate of the composition 60 or 80 through the die 58 or 74 may be, for instance, from about 2 grams/inch to about 9 grams/inch in one embodiment. The flow rate will depend, however, on the composition being applied to the paper web, on the speed of the moving paper web, and on various other factors.

When applying the softening composition to a tissue sheet using an extruder as shown in FIG. 3, in one embodiment, the softening composition may fiberize when extruded through the meltblown die. The ability to fiberize the softening composition may provide various advantages. For example, when formed into fibers, the softening composition is easily captured by the tissue sheet. The fibers may also be placed on the tissue sheet at specific locations. Further, the fibers tend not to penetrate through the entire thickness of the web, but instead, remain on the surface of the web for providing the greatest benefit to the consumer.

The present invention may be better understood with respect to the following example.

### EXAMPLE

A single-ply, three-layered uncreped through-air-dried tissue was produced similar to the process illustrated in FIG. 1. The tissue was made using eucalyptus fibers for the outer layers and softwood fibers for the inner layer. The center layer was refined to levels required to achieve target strength values, while the outer layers provided the surface softness and bulk. The tissue had a basis weight of about 33 to 35 gsm.

The tissue was treated with varying chemical blends of an amino-fuctional polysiloxane, AF-23 obtained from Kelmar Industries Inc., and an ethoxylated alkyl containing 13 to 18 carbon atoms in the carbon chain and containing 9 or 20 moles of ethoxylate, (C13-9EO or C18-20EO). The alkyl chain length and amount of moles of ethoxylate contained in the ethoxylated alkyl represented an average. The amino-fuctional polysiloxane and the ethoxylated alkyl had chemical structures that fit the general chemical structures provided above. The chemical blend was applied by an offset rotogravure printer, similar to the process illustrated in FIG. 2. The chemical blend was mixed with water to create a 30% emulsion. The samples were then tested using the wet-out time test described above.

The following results were obtained:

| | | % Chemical | |
|---|---|---|---|
| Sample | Chemical Blend | add-on | Wet-out-time |
| 1 | 25% AF-23 & 75% C13-9EO | 2% | 6 |
| 2 | 25% AF-23 & 75% C13-9EO | 9% | 22 |
| 3 | 50% AF-23 & 50% C13-9EO | 2% | 10 |
| 4 | 25% AF-23 & 75% C18-20EO | 2% | 6 |
| 5 | 50% AF-23 & 50% C18-20EO | 2% | 23 |

Samples 1 and 4 had wet-out-times of less than 8 seconds. Samples 1 and 4 both had a mixture of 25% AF-23 and 75% of an ethoxylated alkyl, with a chemical add-on of 2%. As shown above, the chemical add-on and the amount of polysiloxane present in the composition had a substantial effect upon the wet-out time of the tissue product.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A tissue product comprising:
at least one tissue web containing pulp fibers, the tissue product having a first side and a second side;
a softening composition applied to at least one side of the tissue product, the softening composition comprising from about 5% to about 30% by weight of an amino-functional polysiloxane having the following structure: 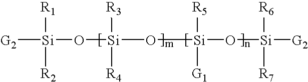
wherein,
m is 10 to 100,000;
n is 1 to 5,000;
G₁ is R₈ or R₁₀—[X—R₁₁]ₛ—Y—R₁₂;
G2 are independently R9, a hydroxyl radical, an alkoxyl radical, or
R₁₀—[X—R₁₁]ₛ—Y—R₁₂;
R₁ through R₉ are independently selected from the group consisting of C₁ to C₈ substituted or unsubstituted, aliphatic or aromatic alkyl radicals;
R₁₀ and R₁₁ are independently a substituted or unsubstituted C₂ to C₆ alkylene diradical;
X and Y are independently a NR₁₃ diradical;
R₁₂ and R₁₃ are independently a hydrogen or a substituted or unsubstituted C₁ to C₂₀ alkyl radical; and
S is 0 or 1;
and from about 70% to about 95% by weight of a chemical having the following structure:
R₁₄—O—[C₂H₄O]_{d}—[C₃H₆O]ₑR₁₅
wherein,
R₁₄ is a saturated or unsaturated, substituted or unsubstituted, primary or secondary straight chain or branched or cyclic C₆ to C₄₀ alkyl radical;
R₁₅ is a hydrogen radical or a C₁ to C₆ alkyl radical;
d is 5 to 40; and
e is 0 to 20;
and wherein the softening composition is applied to the tissue product in a manner and in an amount such that the tissue product has a wet-out time of less than about 8 seconds.

2. A tissue product as defined in claim 1, wherein the softening composition has been applied to both sides of the tissue product, the softening composition being applied to the tissue product such that the total solids add-on is from about 0.5% to about 5% by weight.

3. A tissue product as defined in claim 2, wherein the total solids add-on is from about 0.5% to about 2.5% by weight.

4. A tissue product as defined in claim 2, wherein the softening composition is applied to each side of the tissue product so as to cover from about 40% to about 95% of the surface area of each side of the product.

5. A tissue product as defined in claim 4, wherein the tissue product has a wet-out time of less than about 7 seconds.

6. A tissue product as defined in claim 4, wherein the tissue product has a wet-out time of less than about 6 seconds.

7. A tissue product as defined in claim 4, wherein the tissue product has a wet-out time of less than about 5 seconds.

8. A tissue product as defined in claim 1, wherein the amino-functional polysiloxane comprises a material selected from the group consisting of

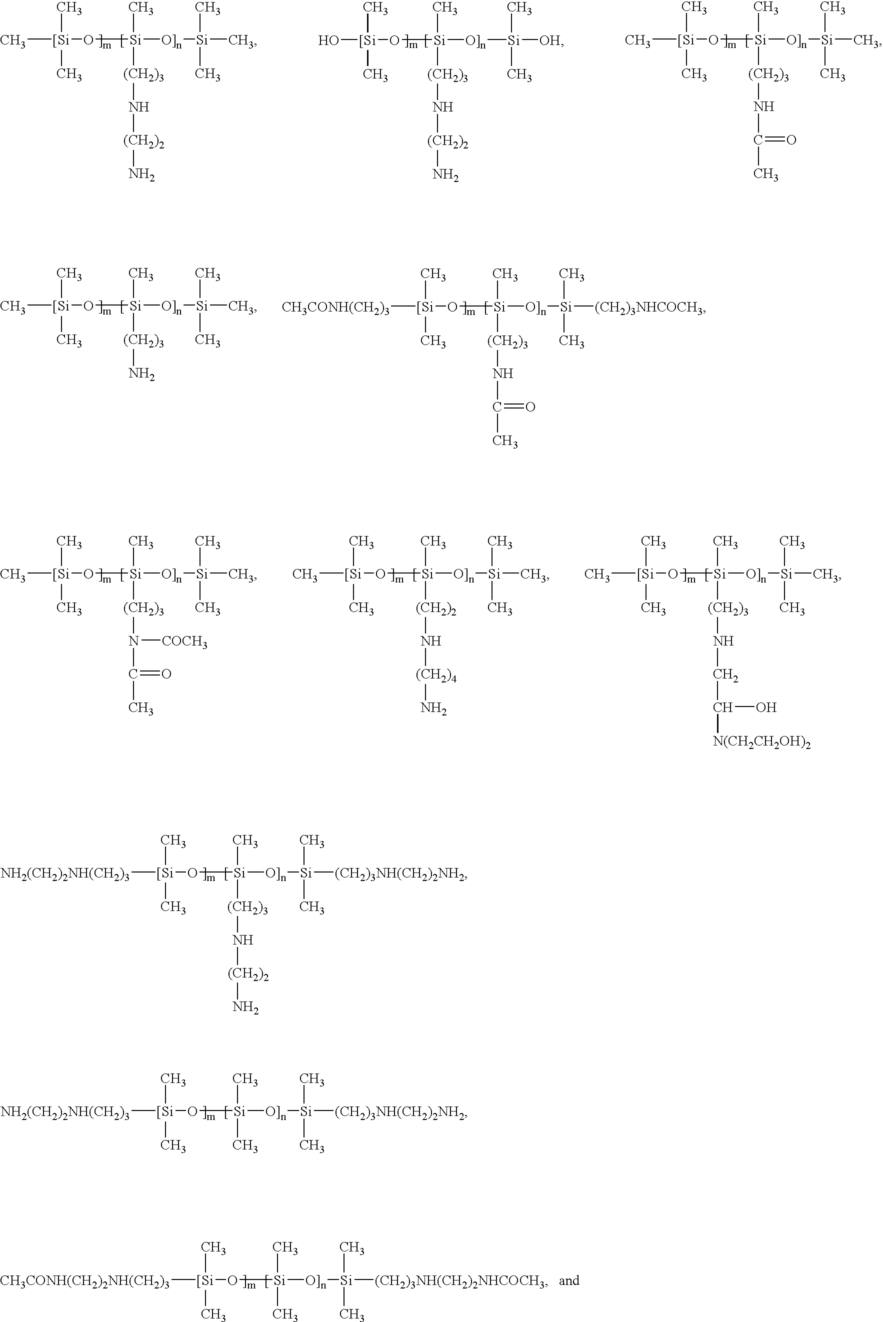

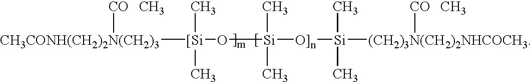

9. A tissue product as defined in claim 1, wherein the chemical contained in the softening composition comprises an alkoxylated alcohol.

10. A tissue product as defined in claim 1, wherein the chemical contained in the softening composition comprises an ethoxylated alcohol wherein R₁₄ includes 12 to 20 carbon atoms in the carbon chain.

11. A tissue product as defined in claim 10, wherein the ethoxylated alcohol contains from about 5 moles to about 25 moles of ethoxylate groups.

12. A tissue product as defined in claim 1, wherein the chemical contained in the softening composition comprises an ethoxylated propoxylated alcohol.

13. A tissue product as defined in claim 1, wherein the chemical contained in the softening composition has a weight ratio of [C₂H₄O]_{d}—[C₃H₆O]ₑR₁₅ to R₁₄ between 1:1 and 7:1.

14. A tissue product as defined in claim 4, wherein the tissue product is a single ply product and wherein the tissue web comprises an uncreped through-air dried web.

15. A method of producing a tissue product comprising:
coating a first side and a second side of a tissue sheet with a softening composition, the tissue sheet containing at least one ply of a tissue web, the tissue web comprising pulp fibers, the softening composition comprising 5% to about 30% by weight of an amino-functional polysiloxane having the following structure: 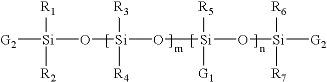
wherein,
m is 10 to 100,000;
n is 1 to 5,000;
G₁ is R₈ or R₁₀—[X—R₁₁]ₛ—Y—R₁₂;
G2 are independently R9, a hydroxyl radical, an alkoxyl radical, or
R₁₀—[X—R₁₁]ₛ—Y—R₁₂;
R₁ through R₉ are independently selected from the group consisting of C1 to C8 substituted or unsubstituted, aliphatic or aromatic alkyl radicals;
R₁₀ and R₁₁ are independently a substituted or unsubstituted C2 to C6 alkylene diradical;
X and Y are independently a NR₁₃ diradical;
R₁₂ and R₁₃ are independently a hydrogen or a substituted or unsubstituted C1 to C20 alkyl radical; and
S is 0 or 1;
and from about 70% to about 95% by weight of a chemical having the following structure:
R₁₄—O—[C2H4O]_{d}—[C3H6O]eR15
wherein,
R₁₄ is a saturated or unsaturated, substituted or unsubstituted, primary or secondary straight chain or branched or cyclic C6 to C40 alkyl radical;
R₁₅ is a hydrogen radical or a C1 to C₆ alkyl radical;
d is 5 to 40; and
e is 0 to 20;
and wherein the softening composition is applied to the tissue sheet in a manner and in an amount such that the tissue sheet has a wet-out time of less than about 8 seconds.

16. A method as defined in claim 15, wherein the softening composition is printed onto the tissue sheet using a rotogravure printer.

17. A method as defined in claim 16, wherein the softening composition is contained in an emulsion when applied to the tissue sheet, the emulsion containing from about 40% to about 90% water.

18. A method as defined in claim 15, wherein the softening composition is applied to the tissue sheet in a substantially neat form by being dispensed through an extruder onto the tissue sheet.

19. A method as defined in claim 15, wherein the softening composition is applied to the tissue sheet so as to have a total solids add-on of from about 0.5% to about 5% by weight.

20. A method as defined in claim 15, wherein the softening composition covers from about 40% to about 99.9% of the surface area of each side of the tissue sheet.

21. A method as defined in claim 15, wherein the softening composition further comprises from about 0.01 % to about 5% by weight of a skin conditioning agent.

22. A method as defined in claim 21, wherein the skin conditioning agent comprises a material selected from the group consisting of aloe, Vitamin E, a herb, a herb extract, or mixtures thereof.

23. A tissue product comprising:
at least one tissue web containing pulp fibers, the tissue product having a first side and second side;
a softening composition applied to the first side and to the second side of the tissue product, the softening composition covering from about 40% to about 99.9% of the surface area of each side of the tissue product, the softening composition being applied to the tissue product so as to have a total solids add-on of from about 0.5% to about 5% by weight, the softening composition comprising from about 5% to about 30% by weight of a hydrophilically-modified amino-functional polysiloxane and from about 70% to about 95% by weight of an alkoxylated alcohol;
and wherein the tissue product has a wet-out time of less than about 8 seconds.

24. A tissue product as defined in claim 23, wherein the tissue product has a wet-out time of less than about 7 seconds.

25. A tissue product as defined in claim 23, wherein the tissue product has a wet-out time of less than about 6 seconds.

26. A tissue product as defined in claim 23, wherein the hydrophilically-modified amino-functional polysiloxane has the following structure: 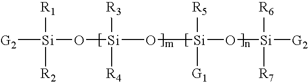
wherein,
m is 10 to 100,000;
n is 1 to 5,000;
G₁ is R₈ or R₁₀—[X—R₁₁]ₛ—Y—R₁₂;
G₂ are independently R9, a hydroxyl radical, an alkoxyl radical, or
R₁₀—[X—R₁₁]ₛ—Y—R₁₂;
R₁ through R₉ are independently selected from the group consisting of C₁ to C₈ substituted or unsubstituted, aliphatic or aromatic alkyl radicals;
R₁₀ and R₁₁ are independently a substituted or unsubstituted C₂ to C₆ alkylene diradical;
X and Y are independently a NR₁₃ diradical;
R₁₂ and R₁₃ are independently a hydrogen or a substituted or unsubstituted C₁ to C₂₀ alkyl radical; and
S is 0 or 1;
and wherein the alkoxylated alcohol has the following structure:
R₁₄—O—[C₂H₄O]_{d}—[C₃H₆O]ₑR15
wherein,
R₁₄ is a saturated or unsaturated, substituted or unsubstituted, straight chain or branched or cyclic C₆ to C₄₀ alkyl radical;
R₁₅ is a hydrogen radical or a C₁ to C₆ alkyl radical;
d is 5 to 40; and
e is 0 to 20.

27. A tissue product as defined in claim 26, wherein the tissue product has a basis weight of from about 10 gsm to about 80 gsm.

28. A tissue product as defined in claim 26, wherein the tissue product has a basis weight of from about 20 gsm to about 40 gsm.

29. A tissue product as defined in claim 28, wherein the tissue product is a single ply product and wherein the tissue web comprises an uncreped through-air dried web.

30. A tissue product as defined in claim 26, wherein the amino-functional polysiloxane comprises a material selected from the group consisting of

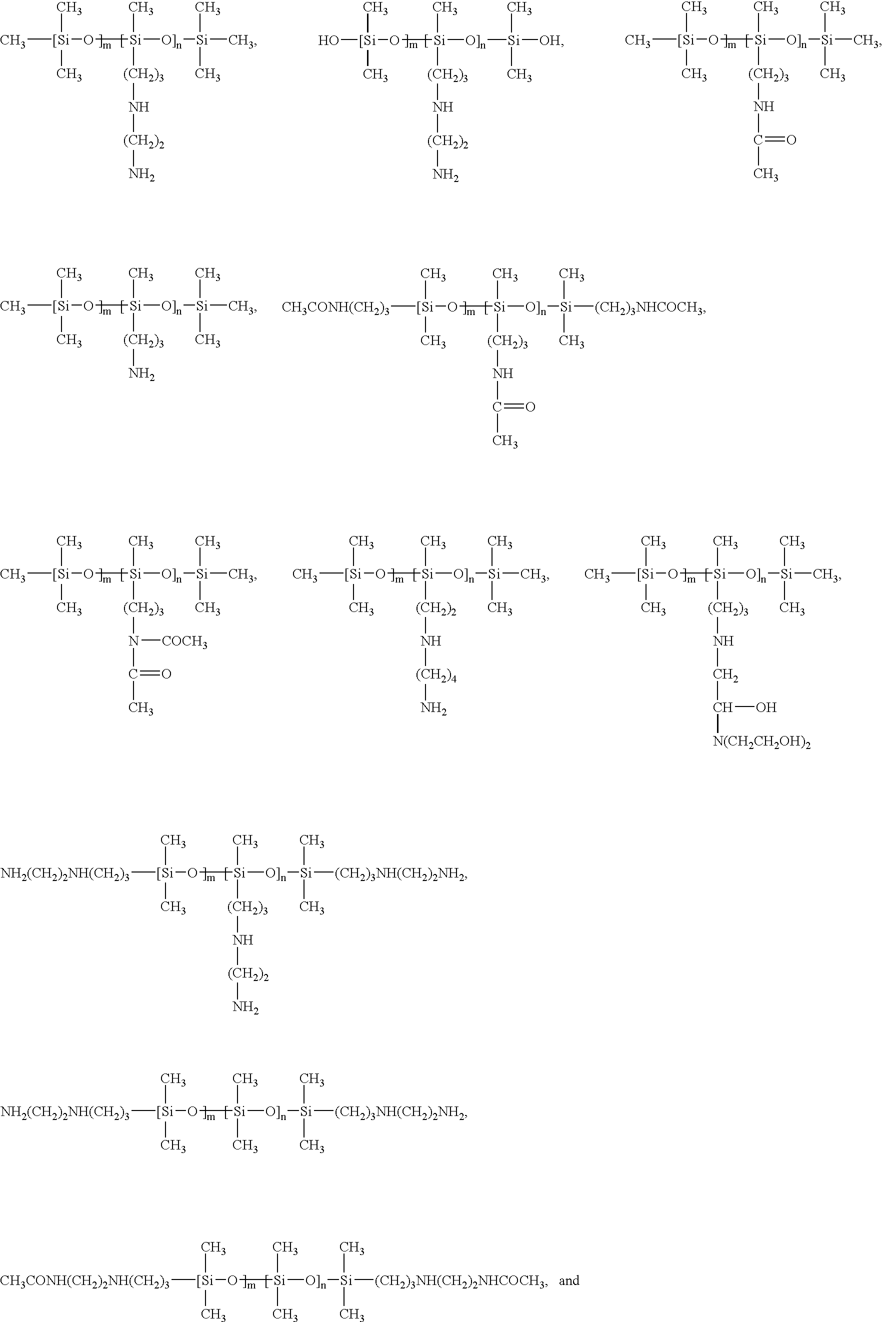

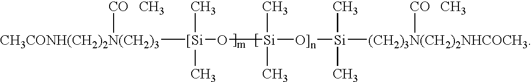

31. A tissue product as defined in claim 26, wherein the softening composition further comprises at least one skin conditioner in an amount of from about 0.01% to about 5% by weight.

32. A tissue product as defined in claim 31, wherein the skin conditioning agent is a material selected from the group consisting of aloe, vitamin E, a herb, a herb extract, or mixtures thereof.
